(19) United States
(12) Patent Application Publication
(10) Pub. No.: US 2024/0396274 A1
(43) Pub. Date: Nov. 28, 2024

(54) STAGGERED PADDLE CARD CONNECTOR

(71) Applicant: Molex, LLC, Lisle, IL (US)

(72) Inventors: Cory R. Ensley, Conway, AR (US); Arturo Casares Valdes, Guadalajara (MX); Michael Garrison, Russellville, AR (US)

(21) Appl. No.: 18/624,152

(22) Filed: Apr. 2, 2024

Related U.S. Application Data
(60) Provisional application No. 63/504,489, filed on May 26, 2023.

(51) Int. Cl. H01R 24/60; H01R 12/72

(52) U.S. Cl. CPC H01R 24/60; H01R 12/721

(57) ABSTRACT

A connector assembly is described that includes a receptacle and a pluggable module. The pluggable module includes a housing, a first paddle card, and a second paddle card. The first paddle card and the second paddle card are oriented vertically with respect to one another at least partially in the housing. The first paddle card has a front end positioned at a first insertion depth and the second paddle card has a front end positioned at a second insertion depth. Due to varying insertion depths, when the pluggable module is inserted into a housing of the receptacle, the first paddle card will come into contact with terminals of the receptacle first before the second paddle card comes into contact with other terminals of the receptacle, providing various stages of insertion and reducing overall force required to mate the receptacle and the pluggable module.

### RELATED APPLICATION

The present application claims priority to U.S. Provisional Patent Application No. 63/504,489 filed on May 26, 2023, which is incorporated by reference in its entirety.

### BACKGROUND

Input/output (IO) connectors are designed with a pluggable module connector that engages a receptacle connector. The pluggable module connector generally includes a paddle card, a form of printed circuit board (PCB), that must be inserted within the receptacle connector. Some pluggable modules include multiple paddle cards, which increase the amount of force required to translate the pluggable module in a port of the receptacle connector.

### TECHNICAL FIELD

The present invention relates to field of connectors and, more specifically, to the field of connectors suitable for supporting high data rates.

### BRIEF SUMMARY

In a first aspect, a connector assembly is described, including: a receptacle; and a pluggable module, including: a housing; and a first paddle card and a second paddle card oriented vertically with respect to one another at least partially in the housing. The first paddle card has a front end positioned at a first insertion depth and the second paddle card has a front end positioned at a second insertion depth. The first insertion depth and the second insertion depth are different from one another.

The first paddle card includes a plurality of top conductive pads and a plurality of bottom conductive pads, and the second paddle card includes a plurality of top conductive pads and a plurality of bottom conductive pads. The receptacle further includes a first plurality of terminals oriented to receive the first paddle card and form an electrical connection with the top and bottom conductive pads thereof. The receptacle further includes a second plurality of terminals oriented to receive the second paddle card and form an electrical connection with the top and bottom conductive pads thereof.

The top and bottom conductive pads of the first paddle card have conductive pad lengths varying from the top and bottom conductive pads of the second paddle card. The front end of the first interface or the front end of the second interface includes a triangular-shaped projection. At least one of the first plurality of terminals and the second plurality of terminals has a straight 50 degree chamfer. The receptacle includes a plurality of insertion fingers defining a port.

In a second aspect, a connector assembly is described, including: a pluggable module, including: a housing; and a first interface and a second interface oriented vertically with respect to one another at least partially in the housing, wherein the first interface has a front end positioned at a first insertion depth and the second interface has a front end positioned at a second insertion depth, the first insertion depth and the second insertion depth being different from one another.

The first interface is a first paddle card, and the second interface is a second paddle card. The first paddle card includes a plurality of top conductive pads and a plurality of bottom conductive pads, and the second paddle card includes a plurality of top conductive pads and a plurality of bottom conductive pads.

The connector assembly further includes a receptacle having a first plurality of terminals oriented to receive the first paddle card and form an electrical connection with the top and bottom conductive pads thereof. The receptacle further includes a second plurality of terminals oriented to receive the second paddle card and form an electrical connection with the top and bottom conductive pads thereof. The top and bottom conductive pads of the first paddle card have conductive pad lengths varying from the top and bottom conductive pads of the second paddle card. The front end of the first interface or the front end of the second interface includes a triangular-shaped projection. At least one of the first plurality of terminals and the second plurality of terminals has a straight 50 degree chamfer. The receptacle includes a plurality of insertion fingers defining a port.

The first paddle card is positioned above the second paddle card with respect to a bottom surface of the pluggable module. Likewise, the first plurality of terminals are positioned above the second plurality of terminals with respect to a bottom surface of the receptacle. The first insertion depth is less than the second insertion depth such that, when the pluggable module is positioned in a housing of the receptacle, the first paddle card comes into contact with the first plurality of terminals prior to the second paddle card coming into contact with the second plurality of terminals.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a top perspective view of a connector assembly in accordance with various embodiments of the present disclosure.

FIG. 2 is a bottom perspective view of a connector assembly in accordance with various embodiments of the present disclosure.

FIG. 3 is a front perspective view of a pluggable module of the connector assembly in accordance with various embodiments of the present disclosure.

FIG. 4 is a front perspective view of a receptacle of the connector assembly in accordance with various embodiments of the present disclosure.

FIG. 5 is a cross-section view of the connector assembly in accordance with various embodiments of the present disclosure.

FIGS. 6 and 7 are top perspective views of paddle cards of the pluggable module in accordance with various embodiments of the present disclosure.

FIG. 8 is a perspective cross-section view of the connector assembly in accordance with various embodiments of the present disclosure.

FIGS. 9A-9C are cross-section views of the connector assembly in accordance with various embodiments of the present disclosure.

FIGS. 10A and 10B are side views of receptacle terminals in accordance with various embodiments of the present disclosure.

FIG. 11 is a graph showing displacement (mm) plotted versus force (N).

### DETAILED DESCRIPTION

The present disclosure relates to a staggered paddle card connector, as well as associated connectors, assemblies, systems, and the like. Connector assemblies often include a pluggable module and a receptacle. In CDFP and CDFP-like connectors, the pluggable module includes one or more paddle cards that, when inserted, couple to terminals within the receptacle, forming an electrical connection therewith for data communication. Currently, controlling proper insertion of the pluggable module remains problematic. For instance, if the pluggable module is not sufficiently translated within a housing of a receptacle, an electrical connection may not be adequately established for high data rates. On the other hand, if the pluggable module is over translated using too much force, the pluggable module and/or the receptacle can be damaged.

Notably, for implementations in which the pluggable module includes multiple paddle cards, a sufficient degree of force is required to push the pluggable connector such that receptacle terminals conductive pads of the paddle cards. The required force can be further enhanced due to the presence of spring fingers positioned on a housing of the receptacle and other characteristics of the receptacle or the pluggable module. Often, due to the large amount of force required to push the pluggable module sufficiently within the housing of the receptacle, too much force is applied, damaging the pluggable module and/or the receptacle.

Accordingly, various embodiments for a connector assembly are described that reduce or provide a more desirably-consistent amount of force required for suitable translation or insertion into a housing of a receptacle. The connector assembly includes a pluggable module and a receptacle. The pluggable module includes a housing, a first paddle card, and a second paddle card. The first paddle card and the second paddle card are oriented vertically with respect to one another at least partially in the housing. The first paddle card has a front end positioned at a first insertion depth and the second paddle card has a front end positioned at a second insertion depth. Due to varying insertion depths, when the pluggable module is inserted into a housing of the receptacle, the first paddle card will come into contact with terminals of the receptacle first before the second paddle card comes into contact with other terminals of the receptacle, providing various stages of insertion and reducing overall force required to mate the receptacle and the pluggable module. Additional force reduction techniques are described herein.

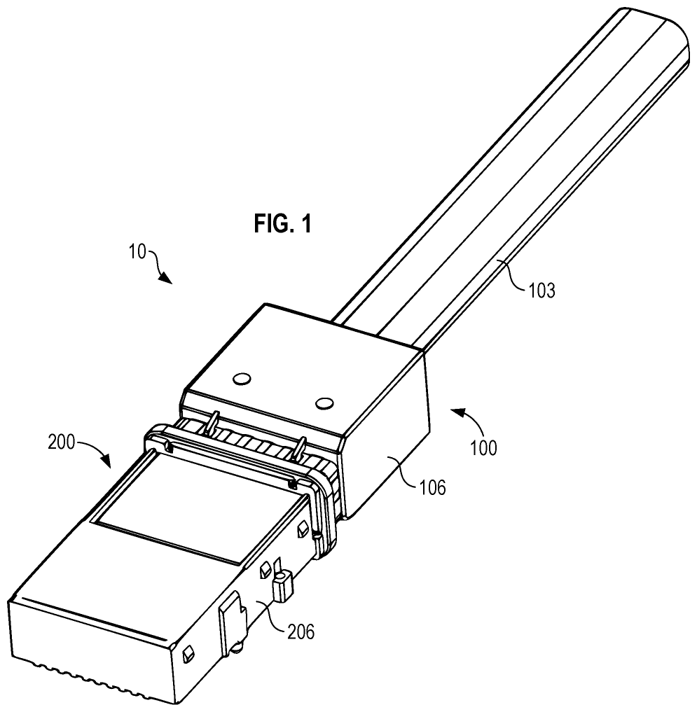

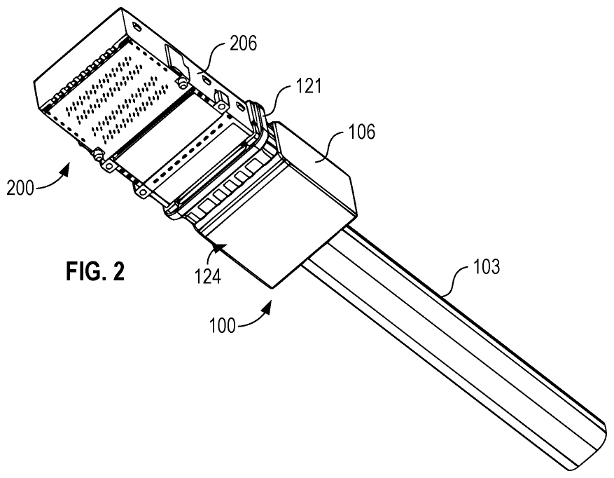

Turning now to the drawings, FIGS. 1 and 2 are top and bottom perspective views, respectively, of a connector assembly 10 in accordance with various embodiments of the present disclosure. The connector assembly 10 may comprise an input/output (I/O) connector assembly and, as such, may be used for small form-factor (SMALL) pluggable applications or dual density SMALL pluggable applications (e.g., QSFP, SFP, QSFP-DD, SFP-DD, OSFP, CDFP applications).

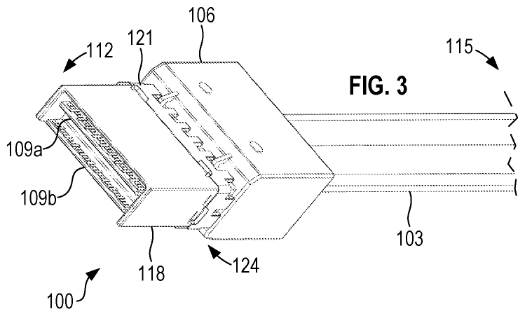

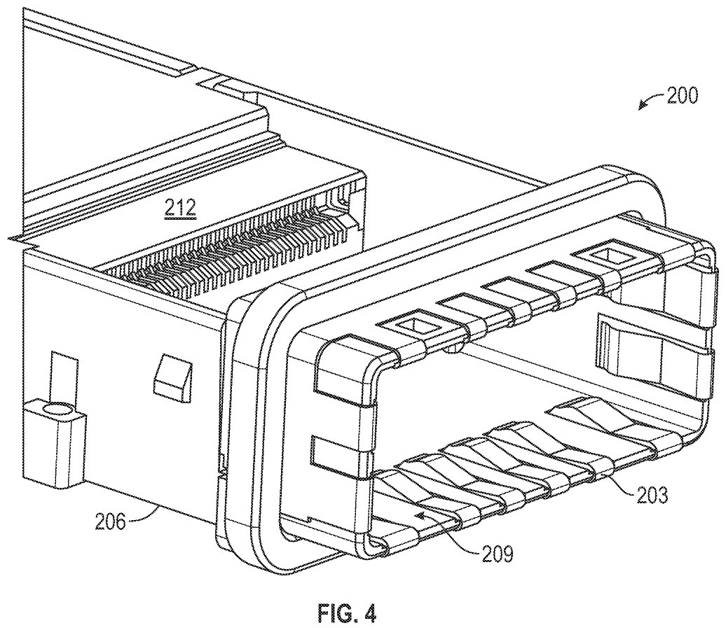

The connector assembly 10 generally includes a pluggable module 100 and a receptacle 200. The pluggable module 100 may include a free-end connector, whereas the receptacle 200 may be coupled to a printed circuit board or like device. FIG. 3 is a front perspective view of the pluggable module 100 with the receptacle 200 omitted, and FIG. 4 is a front perspective view of the receptacle 200 of the connector assembly 10 with the pluggable module 100 omitted in accordance with various embodiments of the present disclosure.

Referring collectively to FIGS. 1-4, the pluggable module includes a cable 103 and a housing 106. The housing 106 includes a first paddle card 109 and a second paddle card 109b (collectively “paddle cards 109”) disposed therein. The first paddle card 109a is shown as a top-most one of the paddle cards 109, and the second paddle card 109b is shown as a bottom-most one of the paddle cards 109. The cable 103 may be one of a multitude of cables terminated to the paddle cards 109, for example.

The housing 106 has a leading or mating end 112 and a rear end 115 opposite the mating end 112. The housing 106 may include a cantilevered shell 118 at the mating end that surrounds or partially surrounds the paddle cards 109 for protection. The housing 106 may be formed in any desired manner and of any desired materials. As examples, the housing 106 can be die cast, machined, or molded. The housing 106 may be formed of metal, plastic, or any other desired material. If desired, the housing 106 may be conductive such as by forming the components of metal or by forming the components of plastic and applying plating as desired.

As shown in FIG. 3, the first paddle card 109a and the second paddle card 109b are oriented vertically with respect to one another and are nested, wholly or at least partially, in the housing 106. The first paddle card 109a is positioned above the second paddle card 109b, and the second paddle card 109b is positioned below the first paddle card 109a with respect to a bottom surface 124 of the housing 106. While two paddle cards 109 are illustrated by way of example, embodiments described herein may relate to connector assemblies 10 with two or more paddle cards 109.

FIG. 4 is a front perspective view of the receptacle 200 of the connector assembly 10. FIG. 4 depicts spring fingers 203 positioned on a front end of a housing 206 of the receptacle 200, where a top surface of the housing 206 is omitted such that an interior of the housing 206 is visible. The spring fingers 203 are positioned on a port 209 in which the pluggable module 100 may be inserted. A receptacle connector 212 may be positioned a predetermined distance within the port 209 where paddle cards 109 of the pluggable module 100 may be inserted therein, as will be described. It is understood that the paddle cards 109 couple to the receptacle connector 212 by virtue of an operating translating the pluggable module 115 through the port 209 until sufficient translation is established.

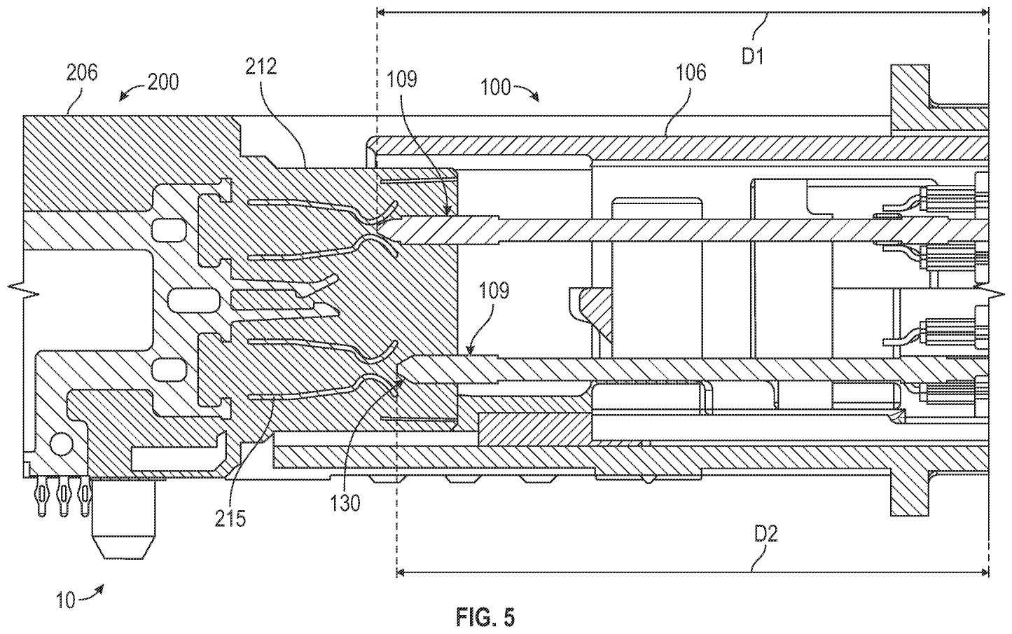

Turning now to FIG. 5, a cross-section view of the connector assembly 10 is shown. It is understood that a sufficient degree of force is required to push the pluggable module 100 such that terminals of the receptacle 200 conductive pads of the paddle cards 109. For instance, generally, the paddle cards 109 would contact terminals of the receptacle 200 at the same time, requiring a spike in force required to sufficiently insert the paddle cards 109 within the terminals. The required force can be further enhanced due to the presence of spring fingers 203 positioned on a housing 206 of the receptacle 200, as well as spring fingers 121 positioned on the housing 106 of the pluggable module 100. Often, due to the large amount of force required to push the pluggable module 100 sufficiently within the housing 206 of the receptacle 200, too much force is applied, damaging the pluggable module 100 and/or the receptacle 200.

However, as shown in FIG. 5, the first paddle card 109a has a front end positioned at a first insertion depth D₁ and the second paddle card 109b has a front end positioned at a second insertion depth D₁. As can be seen in FIG. 5, the first insertion depth D₁ and the second insertion depth D₂ are different from one another. For instance, the first insertion depth D₁ may be greater than the second insertion depth D₂, as shown in FIG. 5. Alternatively, the first insertion depth D₁ may be less than the second insertion depth D₂.

The receptacle 200 or, more specifically, the receptacle connector 212 may include a first plurality of terminals 215 oriented to receive the first paddle card 109a and form an electrical connection with top and bottom conductive pads thereof. Likewise, the receptacle connector 212 may include a second plurality of terminals 215 oriented to receive the second paddle card 109b and form an electrical connection with the top and bottom conductive pads thereof. When the pluggable module 155 is positioned in the housing 206 of the receptacle 200 via the port 209, the first paddle card 109a first comes into contact with the first plurality of terminals 215 on a top row prior to the second paddle card 109b coming into contact with the second plurality of terminals 215 on a bottom row.

The terminals 215 may include opposingly facing terminals that together clamp the paddle cards 109 while engaging with conductive pads thereof. Additionally, as shown in FIG. 5, a front end of at least one of the first paddle card 109a and the second paddle card 109b may include a triangular-shaped projection 130. This may further reduce an amount of force required to position the paddle cards 109 within the terminals 215 of the receptacle connector 212. Moreover, at least one of the terminals 215 may have a straight 30-50 degree chamfer, even further reducing the amount of force required to position the paddle cards 109 within the terminals 215 of the receptacle connector 212.

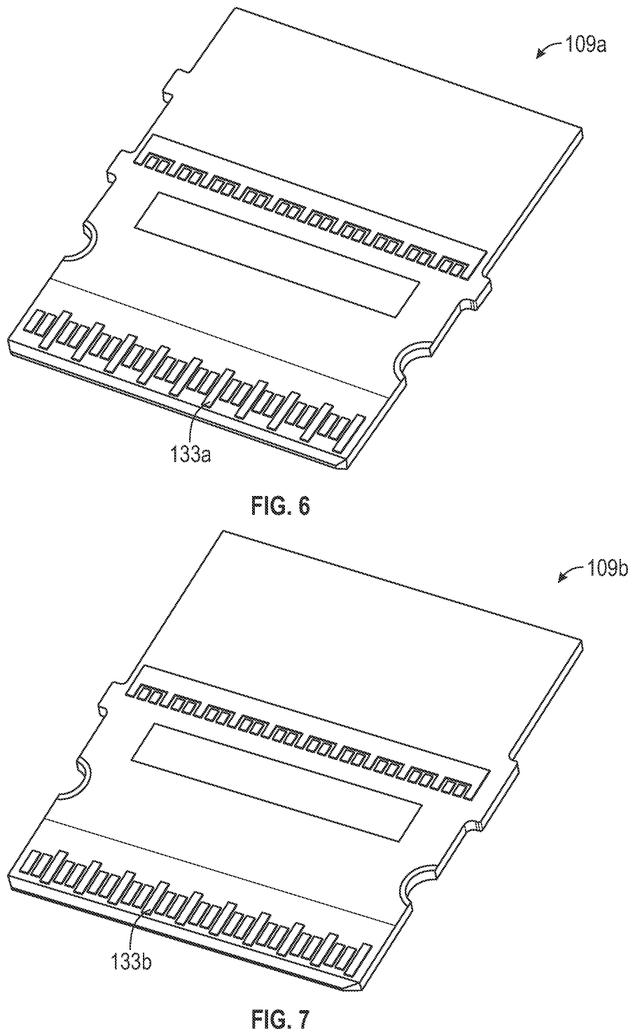

Referring now to FIGS. 6 and 7, top perspective views of paddle cards 109 of the pluggable module 100 are shown in accordance with various embodiments of the present disclosure. As noted above, the paddle cards 109 may include conductive pads 133a, 133b (collectively “conductive pads 133”) positioned on a bottom and/or top surface of the respective conductive pad 133. In various embodiments, the top and bottom conductive pads 133a of the first paddle card 109a have conductive pad lengths varying from that of the top and bottom conductive pads 133 of the second paddle card 109b. For instance, the length of the conductive pads 133a of the first paddle card 109a are shown in FIG. 6 as being greater than the length of the conductive pads 133b of the second paddle card 109b.

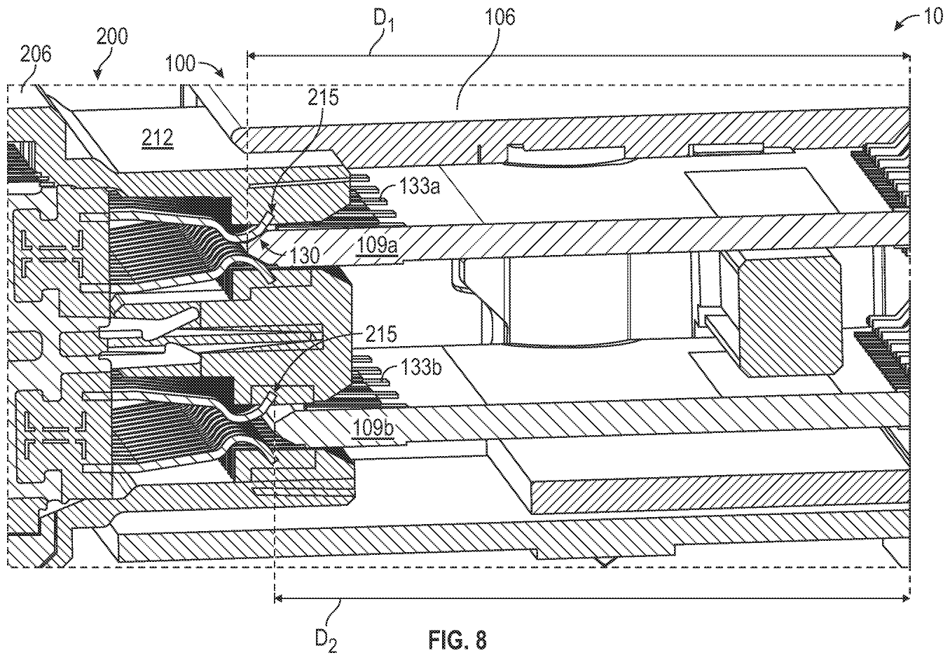

FIG. 8 is another perspective cross-section view of the connector assembly 10 in accordance with various embodiments of the present disclosure. Similar to the view of FIG. 5, the first paddle card 109a has a front end positioned at a first insertion depth D₁ and the second paddle card 109b has a front end positioned at a second insertion depth D₁, where the first insertion depth D₁ and the second insertion depth D₂ are different from one another. For instance, the first insertion depth D₁ may be greater than the second insertion depth D₂.

The insertion depths of the respective paddle cards 109 can be adjusted based on a length of the paddle cards 109, meaning the paddle cards 109 can have varying lengths. For instance, the first paddle card 109a can have a length greater than the second paddle card 109b by 0.6 mm, or other suitable dimension. Additionally, in some embodiments, ground pads of the first paddle card 109a and/or the second paddle card 109b may be shortened as compared to prior paddle cards.

The receptacle 200 or, more specifically, the receptacle connector 212 may include a first collection of terminals 215 oriented to receive the first paddle card 109a and form an electrical connection with top and bottom conductive pads thereof. Likewise, the receptacle connector 212 may include a second plurality of terminals 215 oriented to receive the second paddle card 109b and form an electrical connection with the top and bottom conductive pads thereof. When the pluggable module 155 is positioned in the housing 206 of the receptacle 200 via the port 209, the first paddle card 109a first comes into contact with the first plurality of terminals 215 on a top row prior to the second paddle card 109b coming into contact with the second plurality of terminals 215 on a bottom row. FIG. 8 shows a top collection of terminals 215 coming into contact with the first paddle card 109a, whereas the bottom collection of terminals have not yet come into contact with the second paddle card 109b.

As best illustrated in FIG. 8, the terminals 215 may include opposingly facing terminals that together clamp the paddle cards 109 while engaging with conductive pads thereof. Additionally, the front end of at least one of the first paddle card 109a and the second paddle card 109b may include a triangular-shaped projection 130. This may further reduce an amount of force required to position the paddle cards 109 within the terminals 215 of the receptacle connector 212. Moreover, at least one of the terminals 215 may have a straight 50 degree chamfer, even further reducing the amount of force required to position the paddle cards 109 within the terminals 215 of the receptacle connector 212.

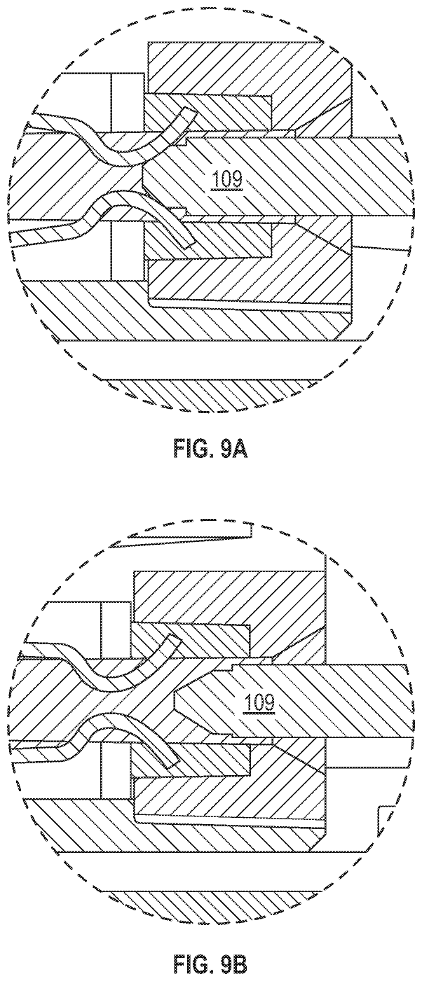

FIGS. 9A-9C are cross-section views of the connector assembly 10 in accordance with various embodiments of the present disclosure. Specifically, FIG. 9A shows a paddle card 109 without the triangular-shaped projection 130 at its front end, instead showing a paddle card 109 of the related art. A generally square or rectangular shape of the front end of the paddle card 109 requires an additional spike in force for insertion or translation within the port 209 of the receptacle 200, whereas, the triangular-shaped projection 130 shown in FIG. 9B requires a less amount of force for positioning. FIG. 9C again shows a top collection of terminals 215 coming into contact with the first paddle card 109a, whereas the bottom collection of terminals have not yet come into contact with the second paddle card 109b.

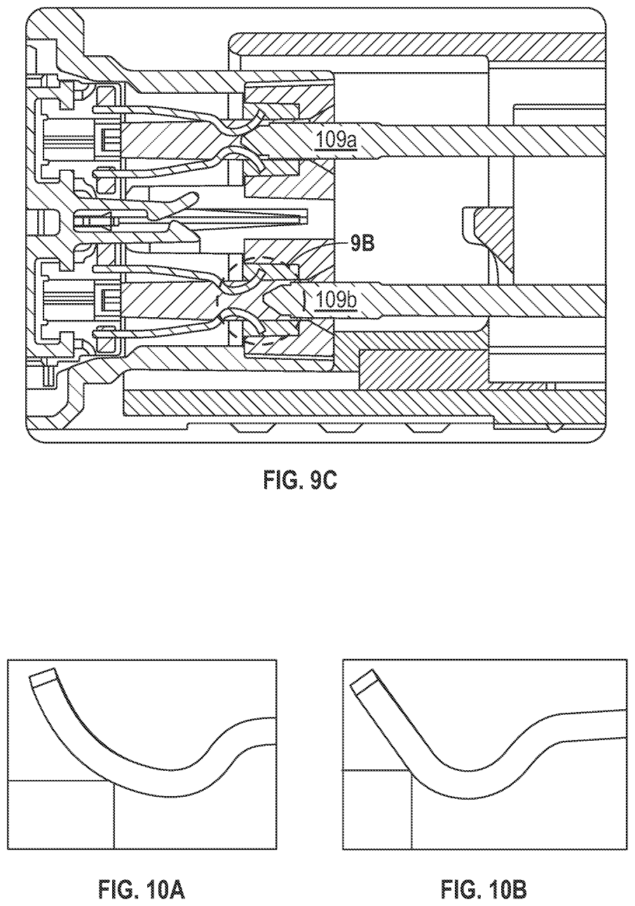

FIGS. 10A and 10B are side views of receptacle terminals in accordance with various embodiments of the present disclosure. FIG. 10A shows terminals of an existing rounded design, where FIG. 10B shows terminals having a straight 50 degree chamfer. The straight 50 degree chamfer reduces the amount of force for translation of the pluggable module 100 with respect to the receptacle 200 or receptacle connector 212.

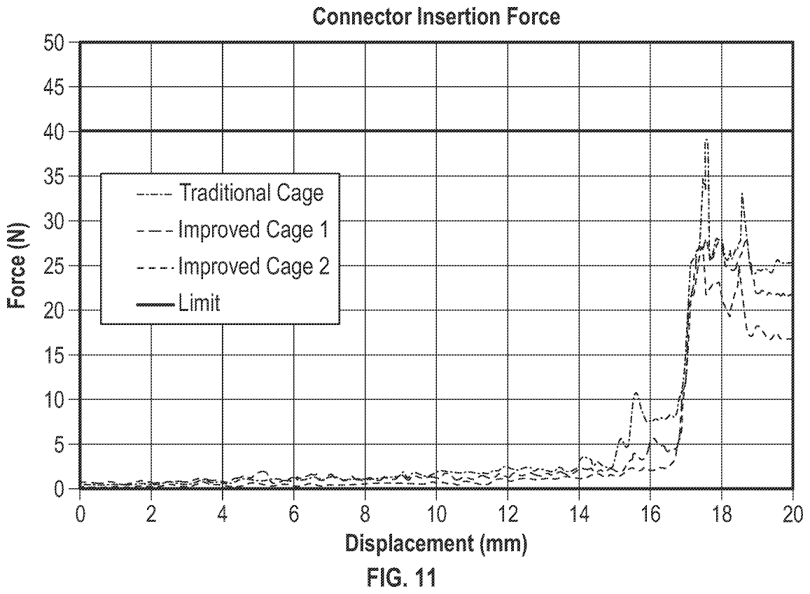

FIG. 11 is a graph showing displacement (mm) plotted versus force (N). The graph shows a predetermined limit of 40 N where likely any force imposed over 40 N would damage the connector assembly 10 or subcomponents thereof. As can be seen with respect to the traditional module, a large amount of force is required for translation as displacement goes beyond 16 mm, close to the limit of 40 N. However, in the improved cage designs, consistent with those described herein, the spike in force is significantly reduced, as can be seen in FIG. 11, due to the staggering of the paddle cards 109 and other force mitigation measures described herein.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A connector assembly, comprising:
a receptacle; and
a pluggable module, comprising:
a housing; and
a first paddle card and a second paddle card oriented vertically with respect to one another at least partially in the housing, wherein the first paddle card has a front end positioned at a first insertion depth and the second paddle card has a front end positioned at a second insertion depth, the first insertion depth and the second insertion depth being different from one another.

2. The connector assembly according to claim 1, wherein the first paddle card comprises a plurality of top conductive pads and a plurality of bottom conductive pads, and the second paddle card comprises a plurality of top conductive pads and a plurality of bottom conductive pads.

3. The connector assembly according to claim 2, wherein the receptacle further comprises a first plurality of terminals oriented to receive the first paddle card and form an electrical connection with the top and bottom conductive pads thereof.

4. The connector assembly according to claim 3, wherein the receptacle further comprises a second plurality of terminals oriented to receive the second paddle card and form an electrical connection with the top and bottom conductive pads thereof.

5. The connector assembly according to claim 4, wherein the top and bottom conductive pads of the first paddle card have conductive pad lengths varying from the top and bottom conductive pads of the second paddle card.

6. The connector assembly according to claim 1, wherein the front end of the first interface or the front end of the second interface comprises a triangular-shaped projection.

7. The connector assembly according to claim 4, wherein at least one of the first plurality of terminals and the second plurality of terminals has a straight 50 degree chamfer.

8. The connector assembly according to claim 1, wherein the receptacle comprises a plurality of insertion fingers defining a port.

9. A connector assembly, comprising:
a pluggable module, comprising:
a housing; and
a first interface and a second interface oriented vertically with respect to one another at least partially in the housing, wherein the first interface has a front end positioned at a first insertion depth and the second interface has a front end positioned at a second insertion depth, the first insertion depth and the second insertion depth being different from one another.

10. The connector assembly according to claim 9, wherein the first interface is a first paddle card, and the second interface is a second paddle card.

11. The connector assembly according to claim 10, wherein the first paddle card comprises a plurality of top conductive pads and a plurality of bottom conductive pads, and the second paddle card comprises a plurality of top conductive pads and a plurality of bottom conductive pads.

12. The connector assembly according to claim 11, further comprising a receptacle, comprising a first plurality of terminals oriented to receive the first paddle card and form an electrical connection with the top and bottom conductive pads thereof.

13. The connector assembly according to claim 12, wherein the receptacle further comprises a second plurality of terminals oriented to receive the second paddle card and form an electrical connection with the top and bottom conductive pads thereof.

14. The connector assembly according to claim 13, wherein the top and bottom conductive pads of the first paddle card have conductive pad lengths varying from the top and bottom conductive pads of the second paddle card.

15. The connector assembly according to claim 9, wherein the front end of the first interface or the front end of the second interface comprises a triangular-shaped projection.

16. The connector assembly according to claim 13, wherein at least one of the first plurality of terminals and the second plurality of terminals has a straight 50 degree chamfer.

17. The connector assembly according to claim 9, wherein the receptacle comprises a plurality of insertion fingers defining a port.

18. The connector assembly according to claim 13, wherein the first paddle card is positioned above the second paddle card with respect to a bottom surface of the pluggable module.

19. The connector assembly according to claim 18, wherein the first plurality of terminals are positioned above the second plurality of terminals with respect to a bottom surface of the receptacle.

20. The connector assembly according to claim 19, wherein the first insertion depth is less than the second insertion depth such that, when the pluggable module is positioned in a housing of the receptacle, the first paddle card comes into contact with the first plurality of terminals prior to the second paddle card coming into contact with the second plurality of terminals.
